(19) United States
(12) Patent Application Publication
(10) Pub. No.: US 2009/0044912 A1
(43) Pub. Date: Feb. 19, 2009

(54) Laminator

(75) Inventor: T.C. Wang, SanChung City (TW)

Correspondence Address: BACON & THOMAS, PLLC, 625 SLATERS LANE, FOURTH FLOOR, ALEXANDRIA, VA, 22314-1176, US

(73) Assignee: Michilin Prosperity Co., Ltd., SanChung City (TW)

(21) Appl. No.: 11/889,791

(22) Filed: Aug. 16, 2007

(51) Int. Cl. B29C 65/00

(52) U.S. Cl. 156/349

(57) ABSTRACT

An improved laminator is disclosed. A guiding outlet is provided above or below the front feeding inlet of the laminator, so that both the guiding outlet and the feeding inlet face the user. This reduces the space required for operating the laminator.

### BACKGROUND OF THE INVENTION

1. Field of Invention

The invention relates to a laminator and, in particular, to an improved laminator whose feeding inlet and the guiding outlet face its user to reduce the space occupied by the laminator and to increase the convenience of operation.

2. Related Art

As is well known, the laminator is used to protect important documents such as photos and identifications. The laminated product is first inserted into a film. The heating element of the laminator radiates heat to pressing rollers. The film and the laminated product are pressed by the high-temperature pressing rollers and combined together.

The feeding inlet of a conventional laminator is normally provided in the front of the laminator, and the guiding outlet is formed opposite to the inlet (i.e., the back of it). Therefore, sufficient space has to be preserved for both the inlet and the outlet for normal operations. This is inconvenient in practice.

### SUMMARY OF THE INVENTION

An objective of the invention is to provide an improved laminator whose feeding inlet and guiding outlet face its user. Therefore, only a space about the size of the laminating document is required in front of the feeding inlet. The space occupied by the laminator for normal operations is thus reduced by a factor of two.

To achieve the above-mentioned objective and to solve problems in the prior art, the invention provides an improved laminator whose guiding outlet is provided above or below the feeding inlet in front of the laminator. This can reduce the space required for the normal operations of the laminator and increase the convenience of operations.

### BRIEF DESCRIPTION OF THE DRAWINGS

The invention will become more fully understood from the detailed description given herein below illustration only, and thus is not limitative of the present invention, and wherein:

FIG. 1 is a three-dimensional view of the invention.

### DETAILED DESCRIPTION OF THE INVENTION

The present invention will be apparent from the following detailed description, which proceeds with reference to the accompanying drawings, wherein the same references relate to the same elements.

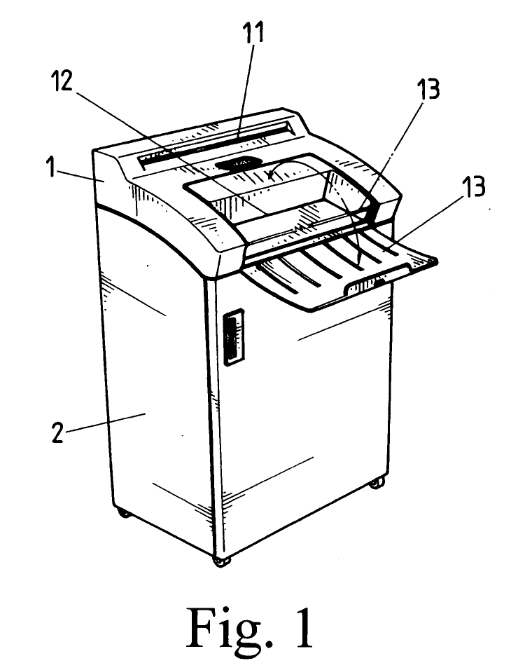

FIG. 1 is a three-dimensional view of the improved laminator of the invention. As shown in the drawing, the housing of the laminator 1 is disposed with a motor, a heating element, and pressing rollers (not shown). An upper position on the front surface of the housing is formed with an inlet 11 for feeding in a laminating document into the laminator. An outlet 12 is formed below and parallel to the inlet 11, so that both the inlet 11 and the outlet 12 face the user of the laminator. A supporting board 13 is provided in the extending direction of the outlet 12 for temporarily holding the laminated documents.

By having the outlet on the same side as the inlet, the space occupied by the laminator is reduced by a factor of two. The user can put the laminator near the edge of a table or against a wall. To operate the laminator, the user only needs to make sufficient space in front of it without moving it. This is very convenient in the manipulation.

In practice, the laminator can be used with a storage closet 2, as shown in the drawing. That is, the laminator 1 is disposed on top of the storage closet 2. The storage closet 2 can store, for example, the laminating films.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An improved laminator, which has an outlet formed on the front surface of its housing in the vicinity of the inlet so that both the inlet and outlet face its user.

2. The improved laminator of claim 1, wherein the outlet is formed below and parallel to the inlet.

3. The improved laminator of claim 1, wherein the outlet is formed above and parallel to the inlet.
